(19) United States
(12) Patent Application Publication
(10) Pub. No.: US 2026/0205328 A1
(43) Pub. Date: Jul. 16, 2026

(54) NAFNET-BASED WIRELESS CHANNEL ESTIMATION

(71) Applicant: Samsung Electronics Co., Ltd., Suwon-si (KR)

(72) Inventors: Xiaochuan Ma, Hillsborough, NJ (US); Guanbo Chen, McKinney, TX (US); Daoud Burghal, San Jose, CA (US); Yan Xin, Princeton, NJ (US); Jianzhong Zhang, Dallas, TX (US)

(21) Appl. No.: 19/440,565

(22) Filed: Jan. 5, 2026

Related U.S. Application Data
(60) Provisional application No. 63/745,217, filed on Jan. 14, 2025.

(51) Int. Cl. H04L 25/02; G06T 5/60; G06T 5/70; G06V 10/44; G06V 10/54; G06V 10/82

(52) U.S. Cl. CPC H04L 25/0254; G06T 5/60; G06T 5/70; G06V 10/44; G06V 10/54; G06V 10/82; G06T 2207/20081; G06T 2207/20084

(57) ABSTRACT

A method for channel estimation includes receiving, by a first electronic device, a signal from a second electronic device over a channel; preprocessing, by the first electronic device, the signal to generate input channel data; and performing, by the first electronic device, channel estimation on the channel based on the input channel data using an artificial intelligence model having a nonlinear activation free network structure.

### CROSS-REFERENCE TO RELATED APPLICATION AND CLAIM OF PRIORITY

The present application claims priority under 35 U.S.C. § 119 (e) to U.S. Provisional Patent Application No. 63/745,217 filed on Jan. 14, 2025, which is hereby incorporated by reference in its entirety.

### TECHNICAL FIELD

This disclosure relates generally to wireless networks. More specifically, this disclosure relates to a method and apparatus for channel estimation using a nonlinear activation free network (NAFNet).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for NAFNet-based channel estimation in wireless communication systems.

In one embodiment, a method for channel estimation is provided. The method includes receiving, by a first electronic device, a signal from a second electronic device over a channel; preprocessing, by the first electronic device, the signal to generate input channel data; and performing, by the first electronic device, channel estimation on the channel based on the input channel data using an artificial intelligence (AI) model having a nonlinear activation free network (NAFNet) structure.

In another embodiment, a first electronic device is provided. The first electronic device includes a memory and a processor operably coupled to the memory. The processor is configured to: receive a signal from a second electronic device over a channel; preprocess the signal to generate input channel data; and perform channel estimation on the channel based on the input channel data using an AI model having a NAFNet structure.

In yet another embodiment, a non-transitory computer readable medium embodying a computer program is provided. The computer program includes program code that, when executed by a processor of a first electronic device, causes the first electronic device to: receive a signal from a second electronic device over a channel; preprocess the signal to generate input channel data; and perform channel estimation on the channel based on the input channel data using an AI model having a NAFNet structure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to example embodiments of the present disclosure;

FIG. 2 illustrates an example gNB according to example embodiments of the present disclosure;

FIG. 3 illustrates an example UE according to example embodiments of the present disclosure;

FIG. 4 illustrates an example network device according to example embodiment of the present disclosure;

FIG. 5 illustrates an example pipeline for NAFNet-based channel estimation (CE) in accordance with example embodiments of the present disclosure according to embodiments of the present disclosure;

FIG. 6 illustrates an example data preprocessing for NAFNet-based CE in accordance with example embodiments of the present disclosure;

FIG. 7 illustrates an example architecture of a NAFNet-based CE model in accordance with example embodiments of the present disclosure;

FIG. 8 illustrates an example structure of a NAF block of FIG. 7 in accordance with example embodiments of the present disclosure;

FIG. 9 illustrates an example gate of a NAF block of FIGS. 7 and 8 in accordance with example embodiments of the present disclosure;

FIG. 10 illustrates an example simplified channel attention performed by the NAF block of FIGS. 7 and 8 in accordance with example embodiments of the present disclosure;

FIG. 11 illustrates example architecture of a NAFNet CE model in accordance with example embodiments of the present disclosure;

FIG. 12 illustrates an example structure of the NAFNet block of FIG. 11 in accordance with example embodiments of the present disclosure; and

FIG. 13 illustrates a flowchart for an example AI-based channel estimation method according to embodiments of the present disclosure.

### DETAILED DESCRIPTION

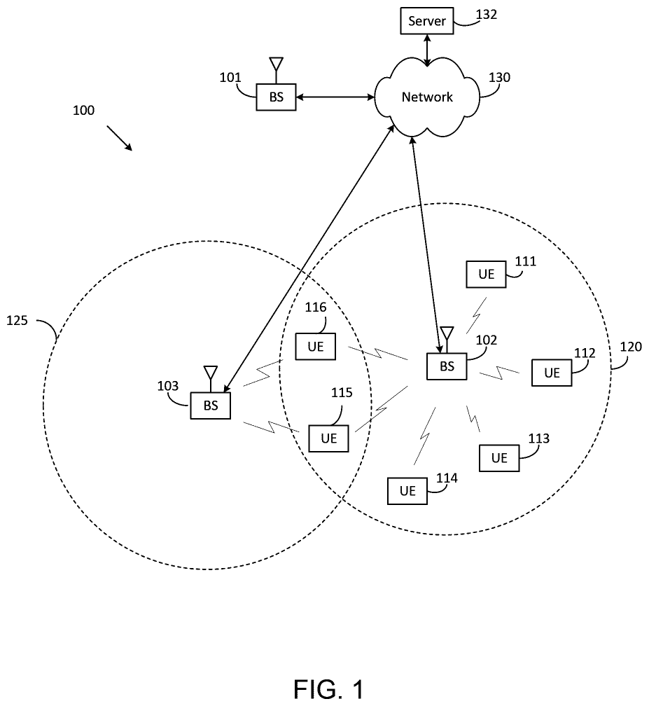

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of NAFNet-based channel estimation techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an artificial intelligence (AI)-based wireless communication system. As such, the at least one network 130 may be operably coupled to an electronic device (e.g., without limitation, a network server) 132 configured to, for example and without limitation, receive data from the gNBs 101-103 via backhaul/network interfaces and train an AI model to perform channel estimation. The server 132 may represent one or more servers, and each server 132 includes a suitable computing or processing device for training the AI/ML model. Each server 132 could, for example, include one or more processing devices, one or more memories storing instructions and data, and one or more network interfaces to receive the data. The AI model is then trained and deployed to effectively perform channel estimation for reliable and efficient communications in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support AI-based channel estimation in wireless communication systems. In certain embodiments, one or more of the gNBs 101-103 include circuitry, programing, or a combination thereof, to utilize data preparation for AI/ML model training in cellular systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

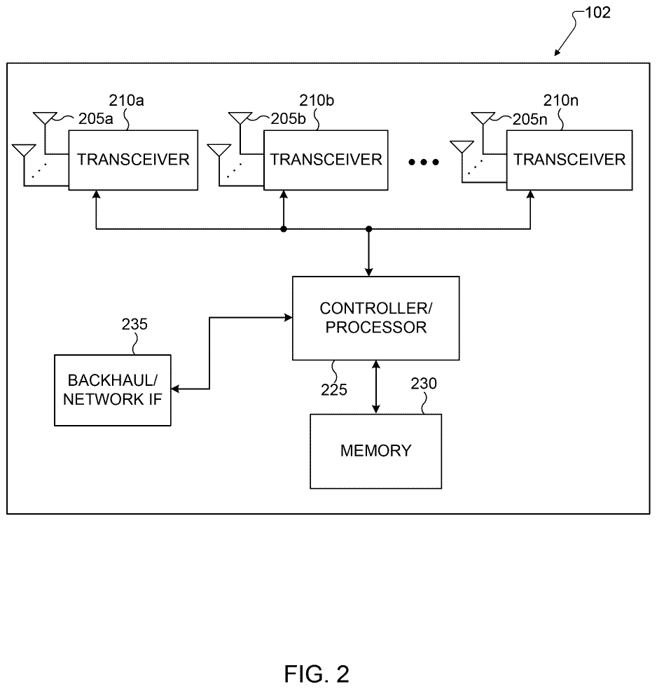

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform NAFNet-based channel estimation in wireless communication systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

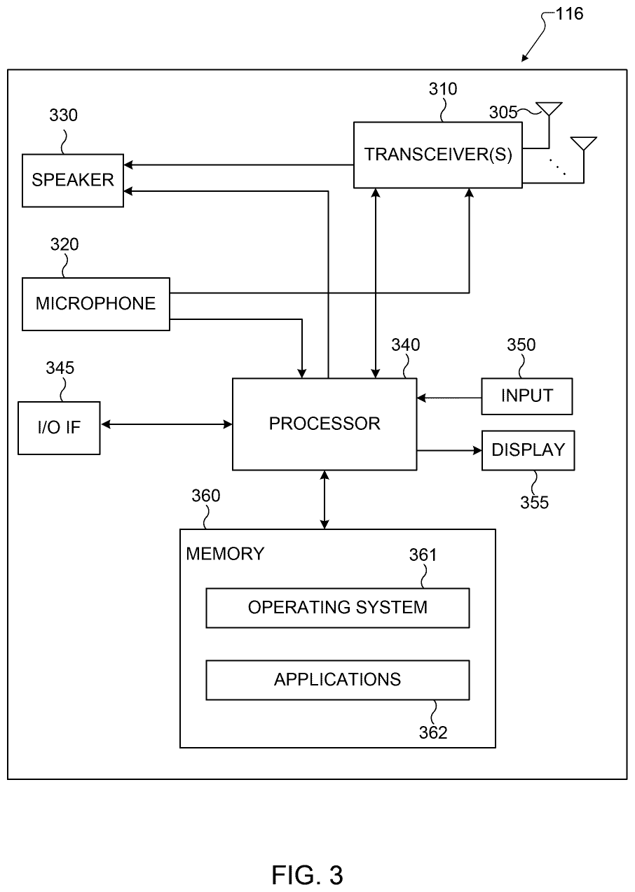

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support NAFNet-based channel estimation in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

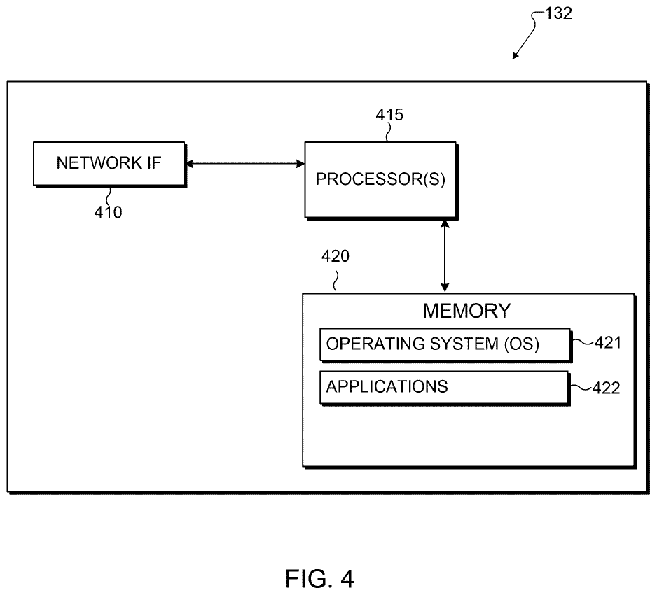

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410 and the UEs 111-116 via the gNBs 101-103.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network as well as a CPU, a GPU or a tensor processing unit (TPU) that provides significant computational resources for training the neural network.

The processor 415 is also capable of executing other processes and programs resident in the memory 420, such as operations that receive and store data. As described in greater detail below, the processor 415 may execute processes to train an AI model to perform channel estimation in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for an AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include data prepared for training of the AI model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

In modern wireless systems, such as those described regarding FIGS. 1-4, channel estimation is a fundamental and critical process that plays a pivotal role in ensuring the reliable transmission of data between transmitters and receivers. Wireless communication systems, however, may be inherently susceptible to various impairments and variations in the radio propagation environment, leading to fluctuations in the channel characteristics. Channel estimation may mitigate the adverse effects of these variations by providing accurate information about the current state of the communication channel.

A wireless channel may be a dynamic medium through which signals transmit, and can be affected by factors such as multi-path fading, interference, noise, and mobility. Channel estimation may provide a critical means to track and adapt to these dynamic changes, allowing the wireless communication system to optimize its performance. In essence, channel estimation may involve estimating channel parameters (such as amplitude, phase and delay), which may be then utilized by the receiver to demodulate and decode transmitted signals accurately.

Some channel estimation methods may rely on pilot signals, which are known symbols inserted into the transmitted signal, allowing the receiver to measure the channel response at specific points in time. These measurements may then be used to interpolate the channel characteristics between the pilot symbols, thus providing an estimate(s) of the channel conditions. However, the channel estimation solutions such as least square (LS) and linear minimum mean square error (LMMSE) may fail to achieve the desirable estimation accuracy with a reasonable complexity, particularly in the low signal-to-noise ratio (SNR) regime.

In recent years, the integration of machine learning techniques into channel estimation processes has gained a substantial attention and shown a great promise in improving the accuracy and efficiency of channel estimation. Machine learning-based channel estimation may leverage the power of AI and data-driven approaches to adapt and learn from the behavior(s) of the wireless channel, making it more robust to varying conditions and potentially reducing the need for explicit pilot signals.

Examples of machine learning-based channel estimation methods may include:
1. Deep Learning Approaches: Deep neural networks, including convolutional neural networks (CNNs), recurrent neural networks (RNNs) and transformer architectures, have been applied to channel estimation tasks. These networks can learn complex relationships between received signals and the channel characteristics, allowing for accurate and efficient estimation.
2. Reinforcement Learning: Reinforcement learning techniques can be used to optimize the transmission and reception strategies in response to changing channel conditions, effectively improving channel estimation and overall system performance.
3. Autoencoders: Autoencoders are neural network architectures that can be used for unsupervised learning of channel representations. They can capture channel characteristics and reduce the reliance on pilot signals.
4. Transfer Learning: Transfer learning techniques enable the adaptation of pre-trained models to specific channel environments, enhancing the generalization of channel estimation algorithms across different scenarios.
5. Diffusion model: Diffusion model includes the denoising diffusion probabilistic models (DDPM) and score matching with Langevin dynamics (SMLD). In particular, a framework for training score-based generative models for MIMO channel estimation has been introduced. Based on the SMLD algorithm, the channel estimation solution in this framework may first learn the score function of the channel data using denoising score matching, obtain the close-form score function of the likelihood, and finally complete the posterior sampling process following the annealed Langevin dynamics.

Machine learning-based channel estimation methods may potentially render the wireless communication systems more adaptive, efficient, and robust, particularly in challenging environments. As the field of machine learning continues to advance, these methods may play an increasingly important role in optimizing the wireless communication systems for a wide range of applications, including 5G, IoT, and beyond.

For example, some machine learning-based channel estimation methods have removed or replaced the nonlinear activation functions (e.g. Sigmoid, ReLU, and GELU) and instead applied a simple network architecture such as a NAFNet. These methods have been shown to achieve the state of the art (SOTA) image restoration performance and low complexity at the same time. As an example, a NAFNet has been shown to achieve 33.69 dB PSNR on GoPro (for image deblurring), exceeding the previous SOTA 0.38 dB with only 8.4% of its computational costs. The NAFNet has also been shown to achieve 40.30 dB PSNR on SIDD (for image denoising), exceeding the previous SOTA 0.28 dB with less than half of its computational costs. Considering the similarity of the image restoration problem (especially the image denoising problem) and the channel estimation problem, a NAFNet may be applied in wireless channel estimation as illustrated in example embodiments of the present disclosure.

This disclosure provides an example NAFNet-based channel estimation (CE) method using an AI model (also referred to as a NAFNet-based CE model or a NAFNet) with a NAFNet architecture. Upon formulating a channel estimation task as an image restoration problem, the NAFNet-based CE model may be applied to the channel estimation task. In order to meet the designs of complexity, and generalizability of PUSCH channel estimation, the NAFNet-based CE model may have a U-shaped network architecture, gate activation, and simplified channel attention (SCA) module such that the NAFNet-based CE model may capture the correlation between the frequency and spatial domains in wireless channel responses more efficiently and effectively, thereby improving channel estimation accuracy and reducing computational complexity.

Further, utilizing the NAFNet-based CE architecture, performing channel estimation may be based on transforming wireless channel data into a multi-color image representation and denoising the multi-color image representation, where the multicolor image representation may be a two-color image representation, e.g., a real-imaginary image representation (a real image representation in one color and an imaginary image representation in another color).

In addition, the NAFNet AI model may be optimized by configuring the NAFNet-based CE architecture to handle adaptive input dimension and perform neural network pruning in order to reduce computational complexity and memory storage.

Through the use of the NAFNet-based CE architecture and optimization, the NAFNet-based channel estimation in accordance with the present disclosure may achieve superior performance with lower complexity and better performance, compared with other deep learning based channel estimation methods.

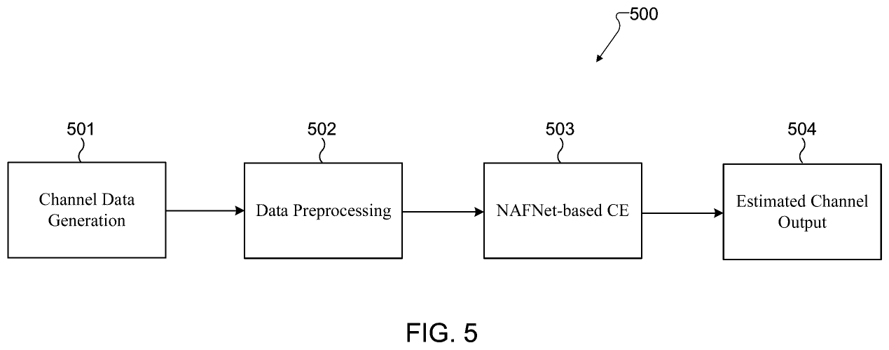

FIGS. 5-13 illustrate non-limiting embodiments of the NAFNet-based channel estimation method, the resultant benefits, and related concepts thereof in greater detail in accordance with the present disclosure.

FIG. 5 illustrates an example pipeline 500 for a NAFNet-based channel estimation method in accordance with example embodiments of the present disclosure. The example pipeline 500 as shown in FIG. 5 is for illustration only, and could have the same or similar configuration. One or more of the components illustrated in FIG. 5 may be implemented in specialized circuitry configured to perform the noted functions or one or more of the components may be implemented by one or more processors executing instructions to perform the noted functions. Other embodiments of the pipeline for the NAFNet-based channel estimation method in accordance with example embodiments of the present disclosure could be used without departing from the scope of this disclosure. FIG. 5 does not limit the scope of this disclosure to any particular embodiment of the NAFNet-based channel estimation pipelines.

As previously mentioned, channel estimation is a process of estimating the wireless communication channel parameters or characteristics, such as its frequency response, delay spread, and fading coefficients. Hence, channel estimation is important for coherent detection and decoding of the transmitted signals, as well as for optimization of the transmission parameters, such as power allocation, modulation scheme, and coding rate. As such, channel estimation can improve the accuracy and reliability of the received signals, and increase the capacity and performance of wireless communication systems.

However, channel estimation can be particularly challenging, especially for high-dimensional signals in systems involving multiple antennas, multiple subcarriers and multiple users. The channel estimation problem can be formulated as finding the optimal solution that best satisfy a system of equations relating the transmitted signals, received signals, channel coefficients and noise. The complexity and difficulty of this problem may depend on the number and arrangement of the channel of the channel coefficients, the availability and quality of the pilot signals, the noise level and distribution, and the channel dynamics and variations. Various methods and techniques have been considered to tackle this problem, such as linear interpolation, least squares, minimum mean square error, maximum likelihood, Bayesian interference, and deep learning.

The example embodiments in the present disclosure may solve the channel estimation problem in the following form. In the frequency domain, the input-output relationship at pilot tones (subcarriers) between the transmitted and received signals can be expressed as:

$$Y = H ⊙ X + N \qquad EQ . ( 1 )$$

Here,

$$Y ∈ {ℂ}^{{N}_{fp} \times {N}_{fn}}$$

are the received signals at pilot tones.

$$H ∈ {ℂ}^{{N}_{fp} \times {N}_{fn}}$$

is the channel matrix, and ⊙ represents the Hadamard product that is an element-wise product.

$$X ∈ {ℂ}^{{N}_{fp} \times {N}_{fn}}$$

are the transmitted pilot signals known to the receiver, and

$$N ∈ {ℂ}^{{N}_{fp} \times {N}_{fn}}$$

is an additive white Gaussian noise (AWGN).

In particular, the mathematical model described in EQ. (1) may be applicable to different types of signal models (e.g., includes but not limited to SISO, SIMO, and MIMO cases etc.). For example, in a SIMO signal model, N_{fp} and N_{fn} can be used to represent the number of the pilot tones (subcarriers) in the frequency domain over one OFDM symbol and the number of the received antennas, respectively. On the other hand, in a SISO case, N_{fp} and N_{fn} can be used to represent the number of the pilot tones (subcarriers) in the frequency domain over one OFDM symbol and the number of the OFDM symbols containing pilot tones, respectively. Note that MIMO signal models can be readily converted to a SIMO case where pilot signals from different transmitted antennas are separated in time, frequency, or code domains.

The goal of the channel estimation task may be to estimate H based on pilot signals X and received signals Y. Without loss of generality, pilot signals X may be assumed as an identity matrix, and thus the signal model in EQ. (1) can be rewritten as:

$$\tilde{H} = H + N . \qquad EQ . ( 2 )$$

Note that the embodiments of this disclosure can be readily applied to cases in which pilot signals X are not an identity matrix. Further, the NAFNet-based CE in accordance with the present disclosure may utilize UL (e.g., SRS or DMRS) or DL (e.g., CSI-RS) reference signals as pilot signals.

Referring back to FIG. 5, the pipeline 500 for NAFNet-based channel estimation in accordance with the present disclosure may include four operations: channel data generation 501, data preprocessing 502, NAFNet-based channel estimation 503, and estimated channel output 504.

Channel data generation 501 may refer to a process to obtain the channel response data or received signal data. In this process, not only the data but also some extra information about the channel or received signals, e.g., signal to noise ratio (SNR) or transmission power may also be estimated and stored. This process can be performed by channel simulation based on wireless channel models or the measurement carried out in the real field. This data may be utilized to train and test a NAFNet-based CE model.

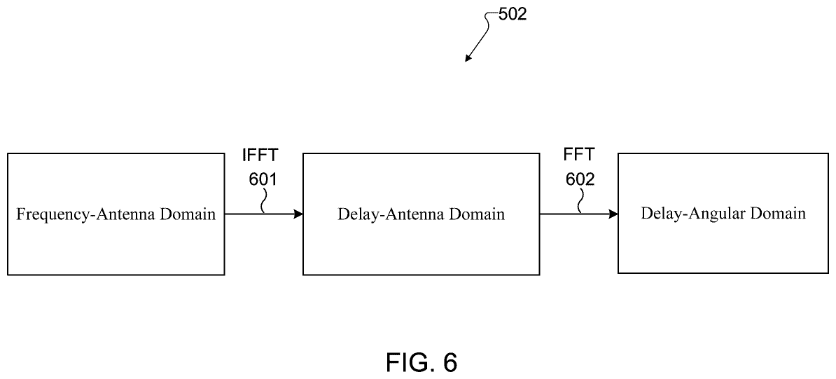

Data preprocessing 502 may be performed on the generated raw channel data so that the channel data may have a better structure and render the model learning easier. Data preprocessing 502 may be discussed further in detail with reference to FIG. 6.

The NAFNet-based channel estimation 503 may be performed by a NAFNet-based CE model, which may be built and trained with the preprocessed data set. The NAFNet-based CE model may be trained to receive a noisy channel response as an input and perform channel estimation based on the noisy channel response. The trained model may be applied to perform the NAFNet-based channel estimation.

The estimated channel output 504 may include the NAFNet-based CE model outputting the estimated channel response.

It is noted that in the PUSCH (physical uplink shared channel) channel estimation it has been challenging to provide accurate estimation for different resource block (RB) sizes (or number of subcarriers). If a channel estimation model has been tested on channel responses with an RB size different from that of the training data, the model may not perform well due to spatial information and receptive field mismatch. For example, if a model is trained with channel data with a small RB size, the model may tend to learn how to catch dependency within a narrow frequency band. If the model is utilized to estimate a channel response with a large RB size, it may not be able to catch long dependency in frequency domain, which is also important in this case. To develop an AI-based channel estimation model capable of functioning effectively across a range of RB size, it may be essential to train the model using a diverse training data set encompassing various RB sizes.

In order to solve this issue, the NAFNet-based CE model may be trained by: (1) selecting a list of RB sizes that can represent the RB sizes, with which the model may be utilized in practice; and (2) in each epoch during training, selecting, for each RB size in the selected list, equivalent amount of data samples and training the model one RB size after the other. For example, when training or testing with smaller RB sizes, a continuous chunk from the frequency dimension may be randomly selected.

FIG. 6 illustrates an example procedure for the data preprocessing 502 for NAFNet-based channel estimation in accordance with example embodiments of the present disclosure. The embodiment of the data preprocessing 502 in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of the data preprocessing for the NAFNet-based channel estimation in accordance with example embodiments of the present disclosure could be used without departing from the scope of this disclosure. FIG. 6 does not limit the scope of this disclosure to any particular embodiment of data preprocessing for the NAFNet-based channel estimation.

The input and output of the NAFNet-based channel estimation model may be the noisy channel response and the true channel response, respectively. The channel response matrix H∈C^{N}^{_{fp}}^{×N}^{_{fn}}. In a SIMO signal model, N_{fp} and N_{fn} can be used to represent the number of the pilot tones (subcarriers) in the frequency domain over one OFDM symbol and the number of the received antennas, respectively.

By transforming the channel response to other domains, such as delay domain or angular domain, the channel data could become sparser. The sparsity of data can bring some benefits to the AI based method:
Regularization Effect: Sparse data may act as a natural form of regularization. When the available data is limited, models may generalize better because they focus on essential patterns rather than memorizing noise.
Feature Importance: Sparse data highlights the importance of features. Rare but informative features may receive more attention from the model.
Efficient Storage and Processing: Sparse representations may utilize less memory and computational resources, making efficient for large-scale applications.

Therefore, the channel response on a transformed domain may be utilized as the input and output of the AI-based channel estimation models.

As illustrated in FIG. 6, the data preprocessing 502 may include two steps. At step 601, the data may be transformed from the frequency domain to the delay domain using Inverse Fast Fourier Transform (IFFT). At step 602, the data may be transformed from the antenna domain to the angular domain utilizing 2-dimensional Fast Fourier Transform (2D FFT) based on the structure of the antennas.

Corresponding to the data preprocessing 502, the estimation result, i.e., the output of the NAFNet-based CE model, may be converted back to the frequency-antenna domain.

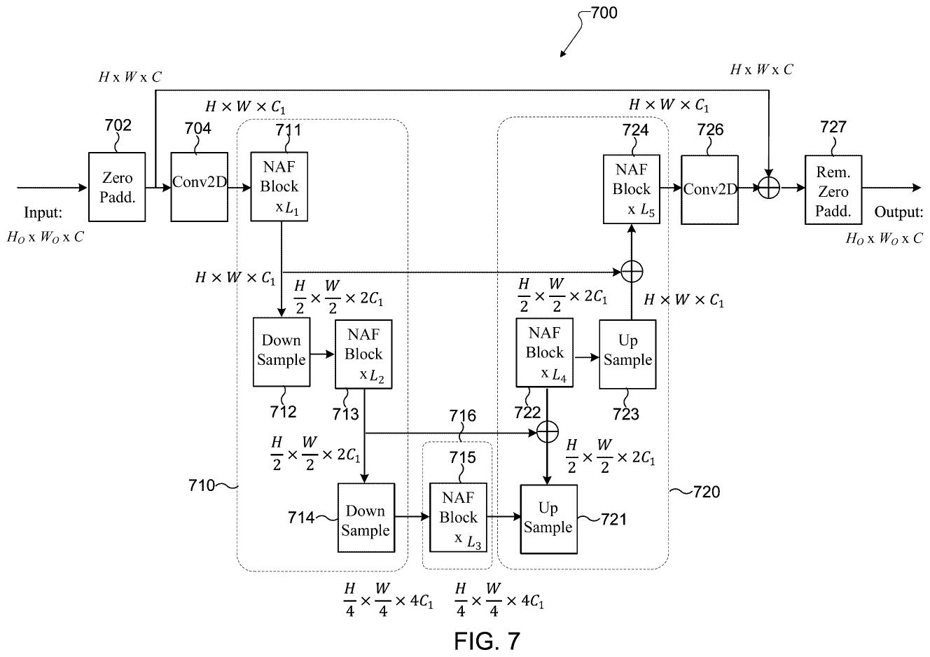

FIG. 7 illustrates an example architecture of a NAFNet-based CE model 700 in accordance with example embodiments of the present disclosure. The example architecture as shown in FIG. 7 is for illustration only, and the architecture could have the same or similar configuration. One or more of the components illustrated in FIG. 7 may be implemented in specialized circuitry configured to perform the noted functions or one or more of the components may be implemented by one or more processors executing instructions to perform the noted functions. Other embodiments of the architecture of a NAFNet-based CE model in accordance with example embodiments of the present disclosure could be used without departing from the scope of this disclosure. FIG. 7 does not limit the scope of this disclosure to any particular embodiment of NAFNet-based CE model architectures.

As shown in FIG. 7, the NAFNet-based CE model 700 may include seven main components: a zero padding adder 702, a shallow feature extractor 704, an encoder 710, a bottleneck component 716, a decoder 720, a reconstruction module 726 and a zero padding remover 727.

The zero padding adder 702 may be a preprocessing part configured to make the input data shape consistent to the NAFNet structure. For example, with an input with height=30 (number of sub-carriers) and width=16 (number of antennas), a size inconsistency error at the second downsampling module may occur because down sample with factor 2 cannot be done on odd number 15 (after the first downsampling module, on frequency domain 30 becomes 15). In this case, zeros may be padded with padding size:

$$\{ \begin{matrix}{P}_{H} = 4 - H mod 4 \\ {P}_{H} = 4 - W mod 4\end{matrix}$$

Here, P_{H} is the padding size for adding on the height dimension and P_{W} is the padding size for adding on the width dimension. The zeros may be padded on one side on height and width dimensions. Therefore, the relationship between the original image size (Hₒ, Wₒ) and the padded image size (H, W) may be:

$$\{ \begin{matrix}H = {H}_{o} + {P}_{H} \\ W = {W}_{o} + {W}_{H}\end{matrix}$$

After data shape adjustments, the input may be passed through the shallow feature extractor 704. The shallow feature extractor 704 may be, e.g., a two-dimensional convolutional (conv2d) layer. The shallow feature extractor 704 may capture low-level features such as edges and textures.

As shown in FIG. 7, the encoder 710 may have multiple encoder layers, and include an initial layer including a NAF Block 711, a first downsampling layer including a downsampler 712 and a second NAF block 713, and a second downsampling layer including another downsampler 714 for further downsampling. While FIG. 7 shows three encoder layers with two downsampling layers, this is for illustrative purposes only and thus an encoder may have more or less encoder layers as appropriate without departing from the scope of this disclosure. The encoder 710 may be responsible for capturing contextual features from the input. The encoder 710 may downsample the input channel using consecutive convolutional layers, gradually decreasing the resolution while increasing the receptive field and the number of feature channels. The encoder 710 may extract relevant features from the input image on different levels, creating a compact representation of the image content.

The bottleneck component 716 may connect the encoder 710 and the decoder 720. The bottleneck component 716 may include NAFNet blocks 715 that transform the encoded features into a suitable format for subsequent processing. The bottleneck component 716 may capture abstract and high-level features of the input content.

As shown in FIG. 7, the decoder 720 may have multiple decoder levels corresponding to the respective encoder levels, and include an upsamling layer including an upsampler 721, a second upsampling layer including a NAF Block 722 and another upsampler 723, and a final NAF block 724. The decoder 720 may be responsible for precise localization and upsampling the feature maps to the original image size. The decoder 720 may upsample the encoded features using transposed convolutions, gradually restoring the original resolution of the input image. The decoder 720 may refine the extracted features by adding the extracted features with skip connections from the corresponding encoder layers, preserving spatial information lost during downsampling. Skip connections may fuse the refined features from the decoder with the corresponding features from the encoder, promoting contextual awareness and improving restoration accuracy.

The final output of the decoder 720 may be passed through the reconstruction module 726, e.g., a convolutional layer applying a non-depthwise (regular, full) 2D convolution. The reconstruction module 726 may map the feature maps back to the channel space, producing the restored channel response.

Corresponding to the zero padding adder 702, the zero padding remover 727 may remove the extra part from the output of the NAFNet in order to make the shapes of input and output consistent. The part to be removed from the output may be the same as the zero padding part added.

The hyper parameter for this NAFNet-based CE model, such as number of channels, number of NAF block in each encoder, decoder and bridge may be obtained via fine-tuning experiments on the dataset. They may be tunable based on the amount of the dataset, computation complexity requirement, memory requirement and so on. These hyperparameters are only illustrative of the principles and should not be considered as restrictive to the possible embodiments.

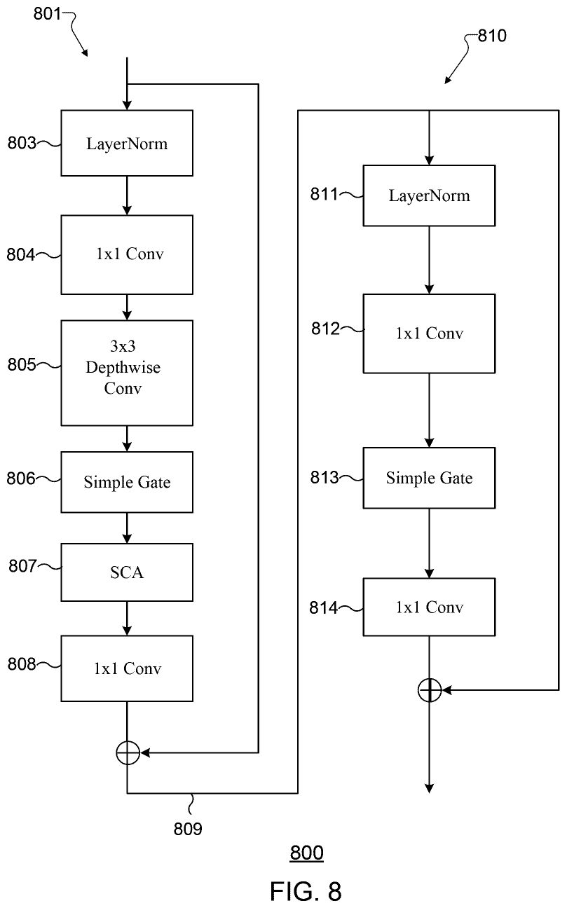

As shown in FIG. 7, the NAFNet 700 may follow a U-Net-like hierarchical structure with an encoder-decoder framework. The NAF block may be a core portion of the NAFNet-based CE model 700 and may include (i.e., but is not limited to) two components: simple gate and simplified channel attention modules as discussed further in detail with reference to FIGS. 8-10.

FIG. 8 illustrates an example structure of a NAF block 800 of the NAFNet-based CE model 700 of FIG. 7 in accordance with example embodiments of the present disclosure. The example structure as shown in FIG. 8 is for illustration only, and the structure could have the same or similar configuration. For example, the NAF blocks 711, 713, 715, 722, and 724 of FIG. 7 may have the same or similar structure as the NAF block 800. One or more of the components illustrated in FIG. 8 may be implemented in specialized circuitry configured to perform the noted functions or one or more of the components may be implemented by one or more processors executing instructions to perform the noted functions. Other embodiments of the structure of a NAF block in accordance with example embodiments of the present disclosure could be used without departing from the scope of this disclosure. FIG. 8 does not limit the scope of this disclosure to any particular embodiment of NAF block structure.

The example NAF block 800 may include a first inverted residual block 801 and a second inverted residual block 810. In the example NAFNet block 800, the LN layer 803 may be first applied to the input feature, and then the first inverted residual block 801 may be utilized. The first inverted residual block 801 may include a first 1×1 convolutional layer 804, a 3×3 depthwise convolutional layer 805, a simple gate module (also referred to as a simple gate) 806, a simplified channel attention (SCA) 807, and a second 1×1 convolutional layer 808. As such, different from other residual blocks, the example NAF block 800 may utilize a simple gate 806 instead of a nonlinear activation function (e.g., ReLU, GeLU), and an SCA 807 instead of other complex channel attention.

Given an input feature X∈ [symbol] ^{H×W×C}, the first 1×1 convolutional layer 804 may expand the number of channels to 2C. The 3×3 depthwise convolutional layer 805 may be utilized to apply spatial filters to each channel independently in order to reduce computational cost. Next, the simple gate 806 may project the feature map back to C channels. Next, the SCA 807 may be utilized to help the network 800 to focus on the important information. Next, the second 1×1 convolutional layer 808 may be utilized as the last component of the first inverted residual block 801.

Subsequently, the second inverted residual block 810 may be applied to the residual sum 809. The second inverted residual block 810 may be a simplified inverted block and only include a LN layer 811, a first 1×1 convolutional layer 812, a simple gate 813, and a second 1×1 convolutional layer 814.

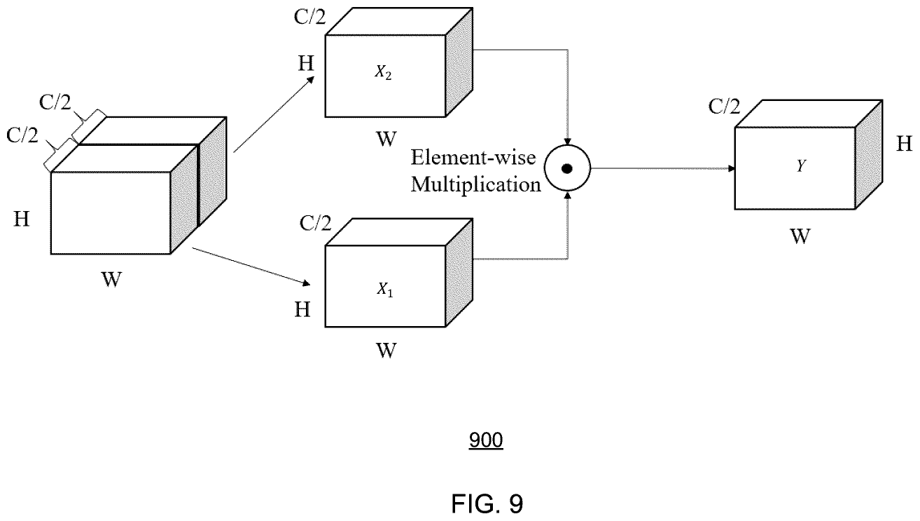

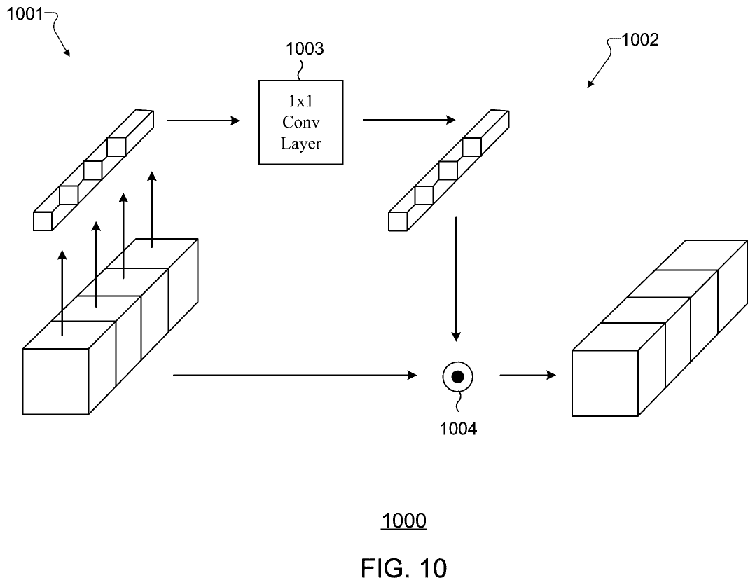

The simple gate 806, 813 and the SCA 807 are discussed further in detail with reference to FIGS. 9 and 10, respectively.

FIG. 9 illustrates an example gating operation 900 of a simple gate 806, 813 in the NAF block 800 of FIG. 8 in accordance with example embodiments of the present disclosure. The example gating operation as shown in FIG. 9 is for illustration only, and different gating operations may be utilized to facilitate NAFNet-based channel estimation. One or more of the components illustrated in FIG. 9 may be implemented in specialized circuitry configured to perform the noted functions or one or more of the components may be implemented by one or more processors executing instructions to perform the noted functions. Other embodiments of gating operations in accordance with example embodiments of the present disclosure could be used without departing from the scope of this disclosure.

The simple gate may be a lightweight and efficient component configured to control the flow of information within the network. It may be designed to replace other activation functions (e.g., ReLU) and gating mechanisms (e.g., Gated Linear Units) with a simpler and more computationally efficient alternative.

As shown in FIG. 9, the simple gate may operate on an input feature X∈ [symbol] ^{H×W×C} Firstly, the simple gate may evenly split the input into two parts on the channel dimension, X=[X₁, X₂]. Here, X₁∈ [symbol] ^{H×W×C/2} and X₂∈ [symbol] ^{H×W×C/2} are the two halves of the input feature map. Then, the simple gate may apply a gating operation on X₁ using X₂ as a gate: Y=X₁*X₂, where Y is the output of the simple gate module and * (also shown as •) is the element-wise multiplication.

The simple gate in accordance with the present disclosure may provide several benefits. First of all, the simple gate may eliminate the need for complex gating mechanisms or nonlinear activation functions, reducing the computation overhead. Further, the simple gate may involve only splitting and element-wise multiplication operations, making it highly efficient in terms of both computation and memory usage. Thus, despite its simplicity, the simple gate can effectively modulate feature maps improving the network's ability to capture and process important information.

FIG. 10 illustrates an example attention operation 1000 of an SCA 807 in the NAF block 800 of FIG. 8 in accordance with example embodiments of the present disclosure. The example attention operation 1000 as shown in FIG. 10 is for illustration only, and different gating operations may be utilized to facilitate NAFNet-based CE. One or more of the components illustrated in FIG. 10 may be implemented in specialized circuitry configured to perform the noted functions or one or more of the components may be implemented by one or more processors executing instructions to perform the noted functions. Other embodiments of attention operations in accordance with example embodiments of the present disclosure could be used without departing from the scope of this disclosure.

By retaining two important roles of channel attention (aggregating global information and channel information), the SCA may be computed as:

$$SCA = X * WPool ( X ) \qquad EQ . ( 3 )$$

The attention weights SCA(X)∈ [symbol] ^{C} for each channel may be obtained by inputting X∈ [symbol] ^{H×W×C} to a 2D average pooling module 1001 and a 1×1 convolution layer 1003. Compared to other channel attention modules, the SCA module may eliminate the need for nonlinear activation functions and only use one 1×1 convolutional layer, thereby reducing computational cost and memory usage significantly.

By adaptively recalibrating 1004 channel-wise feature responses, the SCA module may also help the network to focus on the important information such as blur pattern or noise detections, leading to better image restoration results. Despite its simplicity, the SCA module may thus effectively enhance feature representation and improve the network performance.

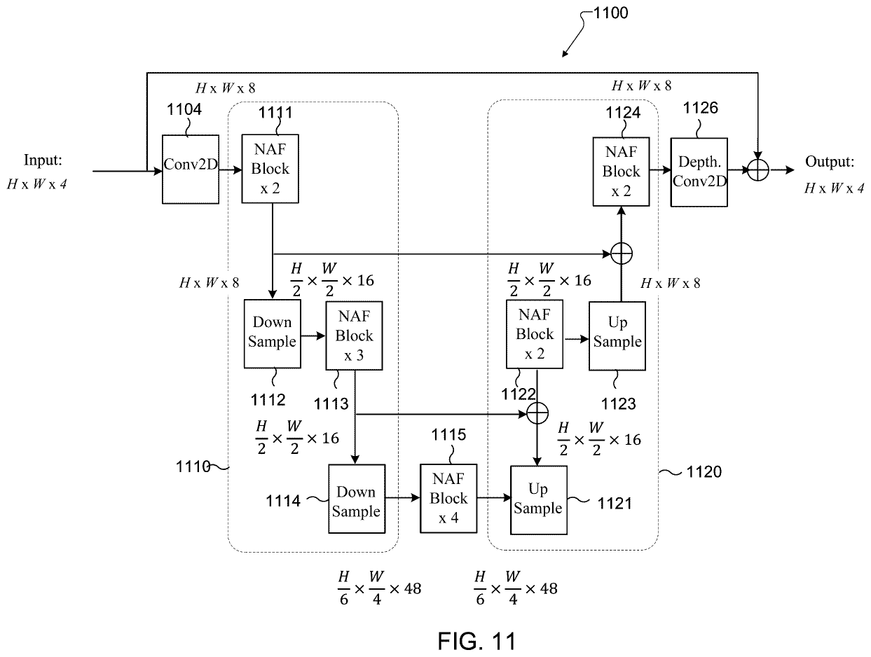

FIG. 11 illustrates another example architecture of a NAFNet-based CE model 1100 in accordance with example embodiments of the present disclosure. The example architecture shown in FIG. 11 is for illustration only, and the architecture could have different configurations. One or more of the components illustrated in FIG. 11 may be implemented in specialized circuitry configured to perform the noted functions or one or more of the components may be implemented by one or more processors executing instructions to perform the noted functions. Other embodiments of the architecture of a NAFNet-based CE model in accordance with example embodiments of the present disclosure could be used without departing from the scope of this disclosure. FIG. 11 does not limit the scope of this disclosure to any particular embodiment of NAFNet-based CE model architectures.

The example architecture of the NAFNet-based CE model 1100 as shown in FIG. 11 is similar to the NAFNet-based CE model 700, but with several non-limiting optimization aspects. As previously mentioned, zero padding may be used to make the input data shape consistent with the NAFNet structure, especially the downsampling module in the encoder. However, zero padding may incur cost. First of all, zero padding may expand the size of input, and thus increase the computational complexity and memory usage. Further, the zero padding can reduce the model performance. For example, zero padding may introduce artificial values around the edges of an input feature map. For channel response in either frequency domain or delay domain, the edges of feature maps can contain important information. The zero padding can obscure or distort this information, leading to a suboptimal feature extraction. Also, zero padding can create artificial edges or boundaries in the input, which may confuse the model or make the model overfit to these artificial patterns.

In the example architecture as shown in FIG. 11, the downsampling module of the NAFNet-based CE Model 700 may be optimized in order to reduce the usage of zero padding in the network. For example, in the second down sampling module 1114, instead of using downsampling factor 2 on the frequency dimension, the downsampling factor 3 may be utilized. Note that in the PUSCH scheme, regardless of the RB size, the number of subcarriers may always be divisible by 6 because there are 12 subcarriers in one RB for systems like 5G and LTE. With this downsampling structure, the zero padding and padding removal parts may be no longer utilized for a PUSCH channel.

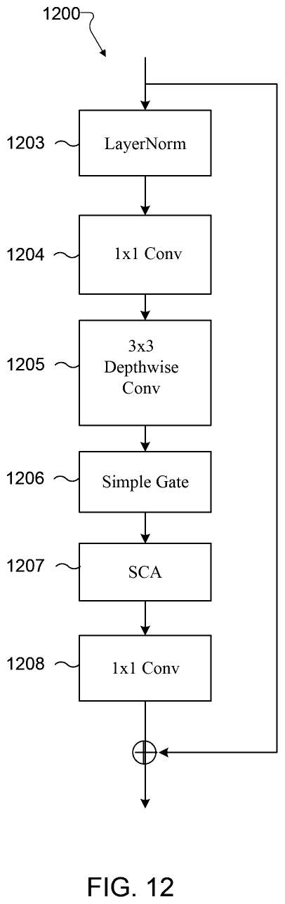

The optimization aspects in the NAFNet-based CE model 1100 may include further simplified NAF blocks as discussed further in detail with reference to FIG. 12.

The optimization aspects may also include utilization of a depthwise convolution layer as a reconstruction module 1126. As a lightweight and efficient alternative of some convolution layer (e.g., a regular, full 2D convolution layer), a depthwise convolution layer may be utilized in lightweight neural network architectures to reduce complexity while maintaining good performance. Therefore, the regular, non-depthwise convolution layer in the reconstruction module 726 of FIG. 7 may be replaced with a depthwise convolution layer in the reconstruction module 1126 of FIG. 11.

By removing the zero padding components through a change of the downsampling factor, removing the second inverted residual block, and utilizing a depthwise convolution layer as the reconstruction module, the NAFNet-based CE model 1100 may further reduce computational complexity and memory usage as compared to the NAFNet-based CE model 700, thereby further improving the model performance therefrom.

FIG. 12 illustrates an example structure 1200 of the example NAFNet block 1111, 1113, 1115, 1122, 1124 of FIG. 11 in accordance with example embodiments of the present disclosure.

The NAFNet-based CE model 1100 may include even further simplified NAF Blocks as compared to those of the NAFNet-based CE model 700. As previously mentioned, the second half 810 of the NAF Block 711, 713, 715, 722, 724 may be a simplified inverted residual block which does not include a simplified channel attention module. In order to improve the feature extraction capability of the whole network, this simplified inverted residual block 810 may be removed from the NAF Block 711, 713, 715, 722, 724. Thus, as shown in FIG. 12, the NAF Blocks 1111, 1113, 1115, 1122, 1124 may include only one inverted residual block, which includes an LN layer 1203, a first 1×1 convolution layer 1204, a 3×3 depthwise convolution layer 1205, a simple gate 1206, an SCA 1207, and a second 1×1 convolution layer 1208.

This removal of the second inverted residual block may further reduce the complexity of the NAF Block 1111, 1113, 1115, 1122, 1124. Thus, even more NAF Blocks may be added in the NAFNet without increasing the total complexity. In this case, since each NAF Block includes an SCA, including more NAF Blocks results in including more attention modules into the NAFNet. By including more SCAs into the network, the feature extraction can be significantly improved.

By utilizing simple gates and simplified channel attention of a NAFNet architecture and/or through further optimizations, the NAFNet-based CE using the NAFNet-based CE models 700, 1100 may significantly improve the performance of the wireless network, especially enhance the communication reliability and capacity for the 5G and 6G wireless communication systems. For example, by providing improved and enhanced UL SRS channel estimation, the NAFNet-based CE may enhance UL throughput performance by providing the base station important information on the quality of the UL channel from each UE, including signal strength, channel fading characteristics, and interference levels. Further, the NAFNet-based CE may enhance DL throughput by providing the improved and enhanced SRS channel estimation. That is, based on the UL CSI obtained from the SRS channel estimation as well as the UL-DL channel reciprocity in a time-division duplexing (TDD) system, the base station can adjust beamforming weights and phase dynamically to improve the DL throughput.

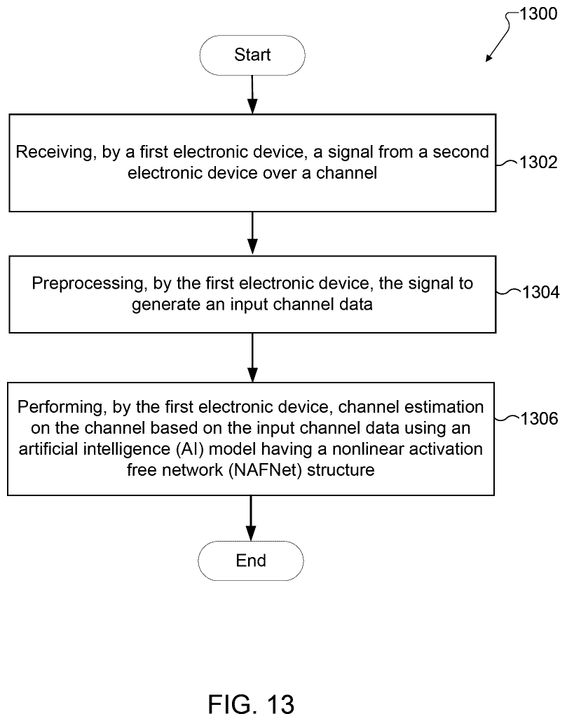

FIG. 13 illustrates a flow chart for a NAFNet-based CE method 1300 according to embodiments of the present disclosure. The embodiment of the NAFNet-based CE method in FIG. 13 is for illustration only. Other embodiments of a NAFNet-based CE method may be used without departing from the scope of this disclosure. In the example of FIG. 13, the NAFNet-based CE method 1300 may be performed by a first electronic device (such as a base station 101-103 of FIGS. 1 and 2).

In the example of FIG. 13, the method 1300 begins at step 1301. At step 1301, the first electronic device may receive a signal from a second electronic device over a channel. The second electronic may be, e.g., a UE 111-116 of FIGS. 1 and 3.

At step 1302, the first electronic device may preprocess the signal to generate input channel data. This may include transforming channel responses in, e.g., the frequency domain to other domains, such as delay domain or angular domain. The channel responses on the transformed domain may be utilized as the input or an output for a CE model.

At step 1303, the first electronic device may perform channel estimation on the channel based on the input channel data using an AI model having a NAFNet structure. The channel estimation may be performed by transforming the input channel data into a channel image including a real channel image in a first color and an imaginary channel image in a second color; and denoising the channel image.

In one embodiment, the AI model may be trained by: generating channel data associated with a synthetic channel; preprocessing the channel data to generate an input channel image shaped based on the NAFNet structure; passing the input channel image to the AI model; and performing channel estimation on the synthetic channel using the AI model.

In one embodiment, the AI model may include: a zero padding component configured to shape an input channel image by adding zeros based on the NAFNet structure; a feature extractor configured to extract, from the input channel image, features including edges and textures; an encoder configured to encode contextual features from the input channel image based on downsampling; a bridging component including NAFNet blocks configured to transform the encoded contextual features to generate feature maps; a decoder configured to restore a resolution and spatial information of the input channel image based on localization, upsampling and skip connections; a reconstructor configured to reconstruct the input channel image; and a zero padding remover configured to remove the added zeros from the input channel image.

In one embodiment, the AI model may include a feature extractor configured to extract, from an input channel image, features including edges and textures; an encoder configured to encode contextual features from the input channel image based on downsampling using a factor of three; a bridging component including NAFNet blocks configured to transform the encoded contextual features to generate feature maps; a decoder configured to restore a resolution and spatial information of the input channel image based on localization, upsampling and skip connections; and a reconstructor configured to reconstruct the input channel image using a depthwise convolution layer.

In one embodiment, the NAFNet structure may include a single inverted residual block including a gate module configured to split an input channel into multiple parts and apply a gating operation on the multiple parts using an element-wise multiplication, and a channel attention module configured to perform a channel-wise attention.

In one embodiment, the NAFNet structure may include a first inverted residual block including a gate module configured to split an input channel into multiple parts and apply a gating operation on the multiple parts using an element-wise multiplication, and a channel attention module configured to perform a channel-wise attention; and a second inverted residual block including a gate module configured to split an output channel from the first inverted residual block into multiple parts and apply the gating operation on the multiple parts using the element-wise multiplication.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method for channel estimation, the method comprising:
receiving, by a first electronic device, a signal from a second electronic device over a channel;
preprocessing, by the first electronic device, the signal to generate input channel data; and
performing, by the first electronic device, channel estimation on the channel based on the input channel data using an artificial intelligence (AI) model having a nonlinear activation free network (NAFNet) structure.

2. The method of claim 1, wherein performing channel estimation comprises:
transforming the input channel data into a channel image including a real channel image in a first color and an imaginary channel image in a second color; and
denoising the channel image.

3. The method of claim 1, wherein the AI model is trained by:
generating channel data associated with a synthetic channel;
preprocessing the channel data to generate an input channel image shaped based on the NAFNet structure;
passing the input channel image to the AI model; and
performing channel estimation on the synthetic channel using the AI model.

4. The method of claim 1, wherein the AI model comprises:
a zero padding component configured to shape an input channel image by adding zeros based on the NAFNet structure;
a feature extractor configured to extract, from the input channel image, features including edges and textures;
an encoder configured to encode contextual features from the input channel image based on downsampling;
a bridging component including NAFNet blocks configured to transform the encoded contextual features to generate feature maps;
a decoder configured to restore a resolution and spatial information of the input channel image based on localization, upsampling and skip connections;
a reconstructor configured to reconstruct the input channel image; and
a zero padding remover configured to remove the added zeros from the input channel image.

5. The method of claim 1, wherein the AI model comprises:
a feature extractor configured to extract, from an input channel image, features including edges and textures;
an encoder configured to encode contextual features from the input channel image based on downsampling using a factor of three;
a bridging component including NAFNet blocks configured to transform the encoded contextual features to generate feature maps;
a decoder configured to restore a resolution and spatial information of the input channel image based on localization, upsampling and skip connections; and
a reconstructor configured to reconstruct the input channel image using a depthwise convolution layer.

6. The method of claim 1, wherein the NAFNet structure comprises:
an inverted residual block including a gate module configured to split an input channel into multiple parts and apply a gating operation on the multiple parts using an element-wise multiplication, and a channel attention module configured to perform a channel-wise attention.

7. The method of claim 1, wherein the NAFNET structure comprises:
a first inverted residual block including a gate module configured to split an input channel into multiple parts and apply a gating operation on the multiple parts using an element-wise multiplication, and a channel attention module configured to perform a channel-wise attention; and
a second inverted residual block including a gate module configured to split an output channel from the first inverted residual block into multiple parts and apply the gating operation on the multiple parts using the element-wise multiplication.

8. A first electronic device comprising:
memory; and
a processor operably coupled to the memory, the processor configured to:
receive a signal from a second electronic device over a channel;
preprocess the signal to generate input channel data; and
perform, channel estimation on the channel based on the input channel data using an artificial intelligence (AI) model having a nonlinear activation free network (NAFNet) structure.

9. The first electronics device of claim 8, wherein to perform channel estimation the processor is further configured to:
transform the input channel data into a channel image including a real channel image in a first color and an imaginary channel image in a second color; and
denoise the channel image.

10. The first electronics device of claim 8, wherein the AI model is trained by:
generating channel data associated with a synthetic channel;
preprocessing the channel data to generate an input channel image shaped based on the NAFNet structure;
passing the input channel image to the AI model; and
performing channel estimation on the synthetic channel using the AI model.

11. The first electronics device of claim 8, wherein the AI model comprises:
a zero padding component configured to shape an input channel image by adding zeros based on the NAFNet structure;
a feature extractor configured to extract, from the input channel image, features including edges and textures;
an encoder configured to encode contextual features from the input channel image based on downsampling;
a bridging component including NAFNet blocks configured to transform the encoded contextual features to generate feature maps;
a decoder configured to restore a resolution and spatial information of the input channel image based on localization, upsampling and skip connections;
a reconstructor configured to reconstruct the input channel image; and
a zero padding remover configured to remove the added zeros from the input channel image.

12. The first electronics device of claim 8, wherein the AI model comprises:
a feature extractor configured to extract, from an input channel image, features including edges and textures;
an encoder configured to encode contextual features from the input channel image based on downsampling using a factor of three;
a bridging component including NAFNet blocks configured to transform the encoded contextual features to generate feature maps;
a decoder configured to restore a resolution and spatial information of the input channel image based on localization, upsampling and skip connections; and
a reconstructor configured to reconstruct the input channel image using a depthwise convolution layer.

13. The first electronics device of claim 8, wherein the NAFNet structure comprises:
an inverted residual block including a gate module configured to split an input channel into multiple parts and apply a gating operation on the multiple parts using an element-wise multiplication, and a channel attention module configured to perform a channel-wise attention.

14. The first electronics device of claim 8, wherein the NAFNET structure comprises:
a first inverted residual block including a gate module configured to split an input channel into multiple parts and apply a gating operation on the multiple parts using an element-wise multiplication, and a channel attention module configured to perform a channel-wise attention; and
a second inverted residual block including a gate module configured to split an output channel from the first inverted residual block into multiple parts and apply the gating operation on the multiple parts using the element-wise multiplication.

15. A non-transitory computer readable medium embodying a computer program, the computer program comprising program code that, when executed by a processor of a first electronic device, causes the first electronic device to:
receive a signal from a second electronic device over a channel;
preprocess the signal to generate input channel data; and
perform, channel estimation on the channel based on the input channel data using an artificial intelligence (AI) model having a nonlinear activation free network (NAFNet) structure.

16. The non-transitory computer readable medium of claim 15, wherein the program code that, when executed by the processor of the first electronic device, causes the first electronic device to perform the channel estimation comprises program code that, when executed by the processor of the first electronic device, causes the first electronic device to:
transform the input channel data into a channel image including a real channel image in a first color and an imaginary channel image in a second color; and
denoise the channel image.

17. The non-transitory computer readable medium of claim 15, wherein the AI model is trained by:
generating channel data associated with a synthetic channel;
preprocessing the channel data to generate an input channel image shaped based on the NAFNet structure;
passing the input channel image to the AI model; and
performing channel estimation on the synthetic channel using the AI model.

18. The non-transitory computer readable medium of claim 15, wherein the AI model comprises:
a zero padding component configured to shape an input channel image by adding zeros based on the NAFNet structure;
a feature extractor configured to extract, from the input channel image, features including edges and textures;
an encoder configured to encode contextual features from the input channel image based on downsampling;
a bridging component including NAFNet blocks configured to transform the encoded contextual features to generate feature maps;
a decoder configured to restore a resolution and spatial information of the input channel image based on localization, upsampling and skip connections;
a reconstructor configured to reconstruct the input channel image; and
a zero padding remover configured to remove the added zeros from the input channel image.

19. The non-transitory computer readable medium of claim 15, wherein the AI model comprises:
a feature extractor configured to extract, from an input channel image, features including edges and textures;
an encoder configured to encode contextual features from the input channel image based on downsampling using a factor of three;
a bridging component including NAFNet blocks configured to transform the encoded contextual features to generate feature maps;
a decoder configured to restore a resolution and spatial information of the input channel image based on localization, upsampling and skip connections; and
a reconstructor configured to reconstruct the input channel image using a depthwise convolution layer.

20. The non-transitory computer readable medium of claim 15, wherein the NAFNET structure comprises:
an inverted residual block including a gate module configured to split an input channel into multiple parts and apply a gating operation on the multiple parts using an element-wise multiplication, and a channel attention module configured to perform a channel-wise attention.
